(19) United States
(12) Patent Application Publication
(10) Pub. No.: US 2024/0385321 A1
(43) Pub. Date: Nov. 21, 2024

(54) Detection Method and Device Based on Quantum Induced Coherence

(71) Applicant: Zhejiang University, Hangzhou City (CN)

(72) Inventors: Dawei WANG, Hangzhou City (CN); Xingqi XU, Hangzhou City (CN); Gewei QIAN, Hangzhou City (CN)

(21) Appl. No.: 18/463,173

(22) Filed: Sep. 7, 2023

(30) Foreign Application Priority Data
May 18, 2023 (CN) 2023105625249

(51) Int. Cl. G01S 17/08; G01S 7/481; G01S 17/89

(52) U.S. Cl. CPC G01S 17/08; G01S 7/4811; G01S 7/4817; G01S 17/89

(57) ABSTRACT

A detection method and device based on quantum induced coherence do not directly measure the signal from the object, but transmit the object information from the first probe light to the locally kept first reference light through quantum coherence. The distance and the image information of the object can be obtained simultaneously from the interference between the first and the second reference light. This non-contact detection method can effectively avoid the background noise induced low signal-to-noise ratio (SNR) in traditional optical remote sensing and quantum illumination radar, and keep it working under saturated attack. Further, the method can simultaneously detect the distance and image information of the object without the joint measurement of two entangled subsystems, and the response wavelength of the detector is different from that of the light wavelength interacting with the object, which greatly reduces the requirement on the detector.

### TECHNICAL FIELD

The invention relates to the technical field of quantum measurement, in particular to a detection method and device based on quantum induced coherence.

### BACKGROUND TECHNIQUE

As a kind of optical remote sensing technology, LiDAR has been widely used in various fields since it came out in the 1960s. Its principle is the same as the traditional microwave or radio radar detection, the detection signal is emitted to the target, and then the reflected signal and the transmitted signal are compared and processed to get a series of parameters of the target. Different targets have different reflectance, which makes it have the ability of target recognition. For different detection targets, different operating wavelengths of LiDAR can be used to achieve targeted detection. LiDAR generally uses laser as a detection signal, because the laser has good directivity, and the pulse can be very short, which makes LiDAR has a high accuracy in imaging and ranging. LiDAR can obtain faster and clearer imaging and more accurate ranging accuracy, which gives it strong support in many areas, including the industrial and military. At present, there are millimeter optical LiDAR detectors in the experiment, and LiDAR also plays a crucial role in unmanned autonomous driving. However, limited by strong environmental scattering and noise, LiDAR still has great defects in weak signal extraction. For example, in extreme weather conditions such as sandstorms, LiDAR will be difficult to use. In addition, other light sources in the environment, such as sunlight, are easy to interfere the signal.

Because of its unique non-local property, quantum entanglement is often used to improve the detection signal-to-noise ratio in weak signal detection. In the field of optical remote sensing and ranging (LiDAR), the ranging technology based on quantum illumination cleverly uses the joint measurement technology to effectively distinguish the weak signal from the noise. In this kind of quantum remote sensing technology, a beam of probe light is generally emitted to detect the object, while another beam of reference light entangled with the detection light is left locally. Because quantum correlations provide additional dimensions, we have a way to distinguish the detected photons from the noisy background that is reflected back. By designing two-photon coincidence counting detection of the reflected probe light and the local reference light, more information from the object to be measured can be obtained than the classical detection methods. However, the existing quantum LiDAR technology based on joint measurement requires the detector to have high quantum efficiency, high time resolution, and high saturation counting. Due to the current state of the art of photodetectors, the ranging accuracy of such quantum radars can only reach the millimeter level, and it can only show its quantum advantage over classical LiDARs under extremely low light conditions. In addition, it still needs to detect the reflected light from the object, which makes it losing its ability to work in extremely noisy environments and under blinding attacks.

### INVENTION CONTENT

In order to overcome the shortcomings of the prior art, the invention provides a detection method and device based on quantum induced coherence.

To achieve the above purpose, the invention provides a detection method based on quantum induced coherence, which comprises:

The entangled light source is pumped to obtain the first mixed light though the first spontaneous parametric down conversion. The first mixed light includes the pumped light, the first reference light and the first probe light. The first reference light and the first probe light entangled with each other.

The first probe light and the first reference light are separated from the first mixed light, and the first probe light is illuminated to the object and the first reference light is illuminated to the reference light mirror located on the local translation stage.

The first probe light is partially reflected by the object, carries the object information and returns to the entangled light source in the original way. The first reference light is reflected to the entangled light source in the original way by the reference light mirror, and the pump light is reflected back to the entangled light source in the original way by the pumped light mirror to obtain the second mixed light by the second spontaneous parametric down conversion. The second mixed light includes the entangled second reference light and the second probe light, the entangled first reference light and the first probe light, and the pump light. The spatial modes of the first reference light and the second reference light overlap, and the spatial modes of the first probe light and the second probe light overlap.

The first reference light and the second reference light are separated from the second mixed light.

The separated first reference light and second reference light are illuminated to the reference light detector.

The local translation stage is adjusted to scan the optical path of the first reference light, and the parameters of the local translation stage are obtained when the visibility of the interference fringes of the two reference lights on the reference light detector is maximum to obtain the distance information of the object to be measured. The image information of the object to be measured is obtained according to the visibility of the interference fringes at different positions on the reference light detector.

According to the first embodiment of the invention, when the object has only one reflecting surface to the first probe light, the distance information of the object to be measured from the entangled light source is obtained according to the local translation stage parameter when the visibility of the interference fringe is maximum.

When the object has multiple reflecting surfaces to the first probe light, the movement of the local translation stage will cause the maximum visibility of the interference fringes on the reference light detector multiple times. The thickness information of the object to be measured is obtained according to the parameters of the local translation stage when the visibility of interference fringes is maximum.

According to the first embodiment of the invention, the wavelengths of the two reference light beams are equal, and the wavelengths of the two probe light beams are also equal, the wavelengths of the probe light and the wavelengths of the reference light are not equal, and the wavelengths of the probe light and the reference light are continuously adjustable.

On the other hand, the invention also provides a detection device based on quantum induced coherence, which comprises a pump light source, an entanglement light source, a transmitting and receiving optical component, and a measuring optical component.

The pump light source pumps the entangled light source to obtain the first mixed light though the first spontaneous parametric down conversion, which includes the pump light, the first reference light and the first probe light. The first reference light and the first probe light entangled with each other.

The transmitting and receiving optical component separates the first reference light, the first probe light and the pump light from the first mixed light. The first probe light is reflected to the object, carries the information of the object and returns to the entangled light source in the original way. The first reference light is reflected to the entangled light source by the reference light mirror located on the local translation stage. The pump light is reflected back to the entangled light source by the pump light mirror though a second spontaneous parametric down conversion to produce a second mixed light. The second mixed light includes the entangled second reference light and the second probe light, the entangled first reference light and the first probe light, and the pump light. Among them, the spatial modes of the first reference light and the second reference light overlap, and the spatial modes of the first probe light and the second probe light overlap.

The measuring optical component separates the first reference light and the second reference light from the second mixed light and illuminate them to the reference light detector. The local translation stage is adjusted to scan the optical path of the first reference light. The parameters of the local translation stage are acquired to obtain the distance information of the object when the two reference light interference fringes on the reference light detector have the maximum visibility. The image information of the object to be measured is obtained according to the visibility of the interference fringes at different positions on the reference light detector.

According to the first embodiment of the invention, the transmitting and receiving optical component comprises a parabolic mirror, a first dichroic mirror, a pumping light mirror, a second dichroic mirror, a translation stage and a reference light mirror located on the translation stage.

The parabolic mirror collimates the first mixed light generated by the entangled light source and reflects the first mixed light to the first dichroic mirror.

The first dichroic mirror reflects the pump light in the first mixed light to the pump light mirror.

The first reference light and the first probe light are transmitted through the first dichroic mirror to the second dichroic mirror.

The second dichroic mirror reflects the first probe light to the object.

The first reference light is transmitted through the first dichroic mirror to the reference light mirror on the local translation stage.

The first probe light is reflected in the original way by the object. The first reference light is reflected in the original way by the reference light mirror. The pump light is reflected in the original way by the pump light mirror. The three are collected by the parabolic mirror and reflected to the entangled light source.

According to the first embodiment of the invention, the pump light mirror, the object, and the reference light mirror are all approximately located on the Fourier plane of the parabolic mirror.

According to the first embodiment of the invention, the measuring optical component includes a third dichroic mirror, a lens, a filter, and a reference light detector.

The third dichroic mirror reflects the first reference light and the second reference light from the second mixed light emitted by the entangled light source.

The lens collects the first reference light and the second reference light reflected by the third dichroic mirror.

The filter is arranged in front of the reference light detector. The filter filters out other interfering light so that the first reference light and the second reference light enter the reference light detector.

A reference light detector is used to measure the interference between the first and second reference light.

According to the first embodiment of the invention, the sensitive surface of the reference light detector is approximately located on the Fourier plane of the lens.

According to the first embodiment of the invention, the pump light source is a light source with an optical isolator, and the quantum induced coherence based detection device also includes a wave plate to adjust the polarization arranged between the pump light source and a third dichroic mirror.

In summary, in the detection method and device based on quantum induced coherence provided by the invention, neither of the two reference beams that form interference to generate detection information directly contact the object, which is a non-contact detection method, and can effectively avoid the disadvantages of low signal-to-noise ratio caused by background noise and saturation attack in traditional optical remote sensing and quantum illumination radar. Further, the detection method provided by the invention can realize the simultaneous detection of distance information and image information of the object without the joint measurement of the two entangled subsystems, thus greatly reducing the requirement on the detector. Moreover, the probe light interacting with the object is of a different wavelength than the reference light that is ultimately measured, which means that the LiDAR we invented can operate in bands where the detector cannot correspond.

In order to make the above and other purposes, features and advantages of the invention more clearly understood, the following is a better embodiment, illustrated in detail with drawings.

### FIGURE DESCRIPTION

FIG. 1 shows a schematic flow diagram of a quantum induced coherence based detection method provided for an embodiment of the invention.

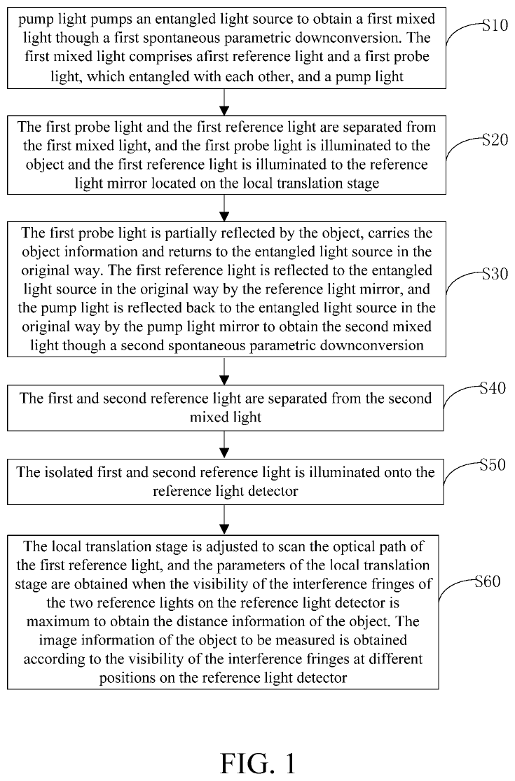

FIG. 2 shows a schematic diagram of the structure of a quantum induced coherence based detection device provided for an embodiment of the invention.

### CONCRETE IMPLEMENTATION METHOD

Quantum entanglement generates a series of entangled photon pairs through spontaneous parametric down conversion process of a nonlinear crystal. Due to the energy conservation in the crystal, the wavelength of the entangled photon is related:

$$\frac{1}{{λ}_{p}} = \frac{1}{{λ}_{s}} + \frac{1}{{λ}_{i}} ,$$

The short wave part λₛ is the signal light, and the long wave part λᵢ is the idler light. In quantum ranging, one beam of light acts as the probe light and the other as the reference light. In this example, long wave idle light is emitted to detect the existence of the object and range. The short wave signal light is left locally as a reference light. The existing quantum illumination ranging technology is based on the joint measurement of reference light and probe light, using the correlation characteristics between the two to achieve better than the classical way of LiDAR signal extraction. Due to the detection strategy of photon counting, the quantum advantage is only manifested at the weak signal level. Due to the limitation of detector performance, the existing ranging resolution is only in the order of millimeters. And because it still needs to detect the reflected light from the object, it can not work properly in the case of large noise environment and saturated attack.

In view of this, the invention provides a detection method based on quantum induced coherence, which comprises: pump light pumps an entangled light source to obtain a first mixed light though a first spontaneous parametric down conversion. The first mixed light comprises a first reference light and a first probe light, which entangled with each other, and a pump light (step S10). The first probe light and the first reference light are separated from the first mixed light, and the first probe light is illuminated to the object and the first reference light is illuminated to the reference light mirror located on the local translation stage (step S20). The first probe light is partially reflected by the object, carries the object information and returns to the entangled light source in the original way. The first reference light is reflected to the entangled light source in the original way by the reference light mirror, and the pump light is reflected back to the entangled light source in the original way by the pump light mirror to obtain the second mixed light though a second spontaneous parametric down conversion (step S30). The second mixed light includes the entangled second reference light and the second probe light, the entangled first reference light and the first probe light, and the pump light. Among them, the spatial modes of the first reference light and the second reference light overlap, and the modes of the first probe light and the second probe light overlap. The first and second reference light are separated from the second mixed light (step S40). The isolated first and second reference light is illuminated onto the reference light detector (step S50). The local translation stage is adjusted to scan the optical path of the first reference light, and the parameters of the local translation stage are obtained when the visibility of the interference fringes of the two reference lights on the reference light detector is maximum to obtain the distance information of the object. The image information of the object to be measured is obtained according to the visibility of the interference fringes at different positions on the reference light detector (step S60).

Based on the principle of quantum induced coherence, the reference light with two path information obtained by two spontaneous parametric down conversions (the first reference light and the second reference light) is the same type of light that is physically indistinguishable (the so-called path information is indistinguishable). For the convenience of description, two reference lights with different path information are named in the way of the first reference light and the second reference light. Similarly, the probe light with two path information obtained by two spontaneous parametric down conversions (the first probe light and the second probe light) is also the same type of light that can not be distinguished physically, and the two probe light beams are named as the first probe light and the second probe light respectively for the convenience of description in the invention.

The detection method based on quantum induced coherence provided in this embodiment shines the first probe light obtained from the first spontaneous parametric down conversion of the entangled light source at the object, and then returns part of its reflected light to the entangled light source again together with the first reference light remaining locally entangled with it and the pump light. Quantum induced coherence occurs with the second probe light and the second reference light produced by the pump light that is reflected back to the entangled light source in the original way. According to the momentum inverse correlation between the first probe light and the first reference light, the path information of the object to be measured carried on the first probe light is also shared in the local first reference light. Thus, the detection signal is copied from the interference-prone first probe light to the local and clean first reference light. On this basis, the spatial modes of the first probe light and the second probe light completely overlap in the entangled light source, and the spatial modes of the first reference light and the second reference light completely overlap in the entangled light source. The setting makes the path information of the two probe lights (referring to the first probe light and the second probe light) indistinguishable from each other, and the path information of the two reference lights (referring to the first reference light and the second reference light) indistinguishable from each other. The visibility of the interference fringe is proportional to the reflectance of the object to the amplitude of the first probe light. When the visibility of the interference fringes on the reference light detector is maximum, the distance between the reference light mirror on the local translation stage and the entangled light source is equal to the distance between the object and the entangled light source. Therefore, the visibility of the interference fringes can be adjusted by moving the local translation stage to scan the optical path of the first reference light, so as to realize the ranging of the object.

The detection method based on quantum induced coherence provided in this embodiment does not directly use the first probe light that is in direct contact with the object to form an interference signal, but copies the information of the object to be measured carried on the first probe light to the first reference light stored locally that is not in contact with the object to form a non-contact range based on the quantum entanglement characteristics. The problem of low signal-to-noise ratio caused by background noise and easy to be affected by saturated attack is effectively avoided. However, the interference of the two reference beams and the scanning of the first reference path by the local translation stage enable the quantum induced coherence detection method provided in this embodiment to detect the distance of the object to be measured without the joint measurement of two entangled subsystems. Moreover, the wavelength of the probe light interacting with the object to be measured and the reference light interfering on the reference light detector are different and both of them are adjustable. This setup greatly reduces the difficulty of measurement and the requirement for the performance of reference light detectors. The selection range of reference light detectors is wider and the cost can be better controlled. Further, based on the momentum inverse correlation between the reference light and the probe light, the quantum induced coherence based detection method provided in this embodiment can simultaneously realize the synchronous detection of the distance information and the image information on the contour of the object.

In addition, unlike the single-point detector used in previous radars, the reference light detector in this example is a planar array camera, which receives an image with a two-dimensional structure and different positions on the image correspond to entangled photon pairs with different wavelength combinations. In the case of saturation blinding attack by high spectral power density laser, only when strict phase matching is achieved, the attack beam and the pump light can trigger the excited parametric down conversion and produce a bright point on the reference light detector, but have no obvious effect on other areas. Saturation attacks of rigorously phase-matched excited parametric down conversion have a very low probability, and even if such interference occurs, the quantum induced coherence based detection method provided in this example can effectively eliminate such saturation attacks by changing the crystal position geometry parameters, such as rotation angle, or changing temperature.

The distance information of the object to be measured includes the distance of the object to be measured from the entangled light source and the thickness of the object to be measured. Specifically, when the object to be measured has only one reflecting surface for the first probe light, only one interference fringe can be detected on the reference light detector when the local translation stage is moved to scan the optical path of the first reference light, and the distance information of the object from the entangled light source can be obtained based on the parameters of the local translation stage at this time. When the object has multiple reflecting surfaces for the first probe light, because the probe light will penetrate the object, reflections will be generated in each reflecting surface. Therefore, the movement of the local translation stage will cause several times of maximum visibility of interference fringes on the reference light detector, and the thickness information of the object can be obtained based on the parameters of the local translation stage at each time of maximum visibility of interference fringes.

In this embodiment, the wavelengths of the two reference lights (the first reference light and the second reference light) are equal, and the wavelengths of the two probe lights (the first probe light and the second probe light) are equal, and the wavelength of the probe light is longer than the wavelength of the reference light and the wavelengths of the probe light and the reference light are continuously adjustable. Specifically, the spectrum of the two reference beams produced by the entangled light source can be covered from visible to infrared. The wide spectral range gives the reference light only a short coherence length, and interference occurs only if the path of the first reference light exiting from the entangled source to the entangled source again is equal to the path of the first probe light exiting from the entangled source to the entangled source again. However, based on quantum entanglement properties, reference light and probe light first probe light are allowed to differ in any dimension, which is not qualified by the present invention.

Based on the pumping of pump light, the first mixed light including pump light, first reference light and first probe light is obtained by the first spontaneous parametric down conversion of entangled light source in step S10. The first probe light and the first reference light need to be separated before performing step S20. Specifically, it can be achieved by setting up two dichroic mirrors. Similarly, in step S40, two reference beams (the first reference light and the second reference light) can be separated from the second mixed light by setting up a dichroic mirror.

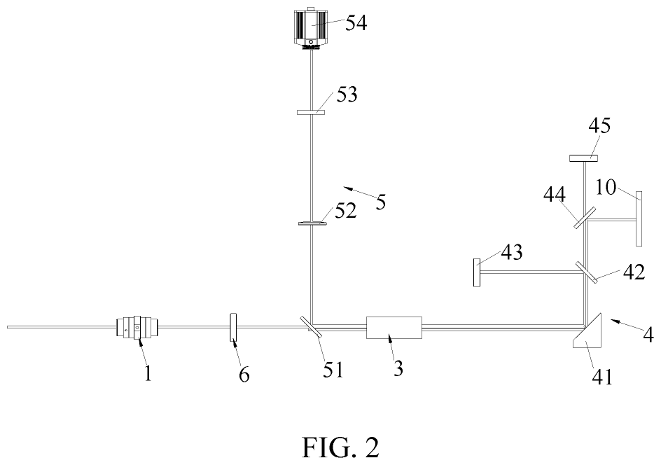

Corresponding to the above quantum induced coherence based detection method, as shown in FIG. 2, the example provides a quantum induced coherence based detection device, which comprises a pumping light source 1, an entanglement light source 3, an transmitting and receiving optical component 4, and a measuring optical component 5. Specifically, based on the pumping of the pump light source 1, the entangled light source 3 undergoes the first spontaneous parametric down conversion to produce the first probe light and the first reference light entangled with each other. In this embodiment, the pump light output by the pump light source 1 is a green laser with a linewidth of 10 KHZ with a center frequency of 532 nm. The nonlinear crystal used in the entanglement light source 3 is a type-0 periodically polarized lithium niobate crystal (PPLN) with a length of 20 mm, a width of 1 mm and a height of 1 mm. However, the present invention makes no qualification in this regard. In other embodiments, the center frequency and linewidth of the pump light can also be adjusted according to the detection requirements; Similarly, the entangled light source 3 can also use nonlinear crystals made of other materials, and its size can be adjusted as needed.

In this embodiment, the pump light source 1 is a light source with an optical isolator, which also includes a wave plate 6 for adjusting the polarization of the pump light. In the application, the laser light emitted by the pump light source 1 is collimated on the optical platform and passed through the optical isolator, which can prevent the reflected light from causing damage to the pump light source 1. After polarization adjustment of the wave plate 6, the pump light collimation is driven into the entangled light source 3. In the present embodiment, the diameter of the pump light for collimating into the entangled light source 3 is 0.42 mm. In this embodiment, the entangled light source 3 is installed in a constant temperature oven, the purpose of which is to control the temperature of the entangled light source 3 so that the entangled light source 3 meets different phase matching conditions. Preferably, the temperature of the entangled light source 3 is set at 146.4 degrees Celsius to obtain a reference light of 893 nm and a probe light of 1316 nm. However, the present invention makes no qualification in this regard.

The transmitting and receiving optical component 4 separates the first probe light that illuminates the object 10, the first reference light that illuminates the reference light mirror 45 on the local translation stage and the pump light that illuminates the pump light mirror 43 from the first mixed light produced by the entangled light source 3. Based on the reflection of the object 10, the reference light mirror 45, and the pump light mirror 43, part of the first probe light, the first reference light, and the pump light are returned to the entangled light source 3. The pump light returned from the original path pumps the entangled light source a second time to produce the second mixed light including the pump light, the first probe light, the first reference light, the second probe light and the second reference light.

Specifically, as shown in FIG. 2, the transmitting and receiving optical component 4 comprises a parabolic mirror 41, a first dichroic mirror 42, a pump light mirror 43, a second dichroic mirror 44, and a reference light mirror 45 located on a translation stage. The parabolic mirror 41 is used to collimate the first reference light and the first probe light generated from the entangled light source 3, and to reflect the first mixed light to the first dichroic mirror 42. In addition, parabolic mirror 41 is used to collect part of the first reference light reflected from the original path, the first probe light, and the pump light. The first dichroic mirror 42 reflects the pump light from the first mixed light to the pump light mirror 43. The first reference light and the first probe light are transmitted through the first dichroic mirror 42 to the second dichroic mirror 44. The second dichroic mirror 44 reflects the first probe light to the object 10 located roughly in the Fourier plane of parabolic mirror 41. The first reference light is transmitted through the second dichroic mirror 44 to the reference light mirror 45 located on the local translation stage. Part of the first probe light is reflected from the original path of the object 10 to the entangled light source 3. The first reference light is reflected by the reference light mirror 45 to the entangled light source 3; The pump light is reflected by the pump light mirror 43 to the entangled light source 3, and the entangled light source 3 is pumped a second time to produce a second reference light and a second probe light. The pump light, the first reference light, the first probe light, the second reference light and the second probe light constitute the second mixed light. However, the present invention does not limit the specific structure of the transmitting and receiving optical component and the placement position of each component. The structure of other transmitting and receiving optical components which can separate the first probe light and the first reference light from the first mixed light so that the two are respectively directed at the object and the reference light mirror are within the protection scope of the invention.

In this embodiment, the measuring optical component 5 includes a third dichroic mirror 51, a lens 52, a filter 53, and a reference light detector 54. The third dichroic mirror 51 reflects the first and second reference light from the second mixed light. Lens 52 is used to collect the reflected first and second reference light. The filter 53 is placed in front of the reference light detector 54 and filters out other wavelengths of light that are not intended to be detected, ensuring that only two reference light beams enter the reference light detector 54. The reference light detector 54 measures the interference between the first reference light and the second reference light.

In this embodiment, the pump light mirror 43, the object to be measured 10, and the reference light mirror 45 are all roughly located on the Fourier plane of the parabolic mirror 41. The sensitive surface of the reference light detector 54 is also roughly on the Fourier plane of lens 52. This setting enables optimal lateral resolution of the interference fringes obtained on the reference light detector 54. However, this invention makes no qualification in this regard.

Based on the scanning of the optical path of the first reference light by the local translation stage equipped with the reference light mirror 45, the parameters of the translation stage on the reference light detector 54 when the two reference light interference fringes have the maximum visibility are obtained to obtain the distance information of the object to be measured 10. The image information of object 10 is obtained based on the intensity of interference fringes at different positions on the reference light detector 54. Specifically, when the parameters of the translation stage with the maximum visibility of the interference fringes are obtained, the distance between the local translation stage and the entangled light source 3 can be measured by actual measurement or other optical path measurement methods, and then the distance between the object to be measured 10 and the entangled light source 3 can be obtained. For the surface profile detection of the object, due to the anti-correlation characteristics of the momentum of the reference light and the probe light, the maximum visibility of the interference fringe at different positions on the reference light detector is recorded. The maximum visibility of the interference fringe at different positions corresponds to the reflectivity of the first probe light at different positions of the object, that is, the image of the object to be measured.

In summary, in the detection method and device based on quantum induced coherence provided by the invention, neither of the two reference beams that form interference to generate detection information directly contact the object to be measured, which is a non-contact detection method, and can effectively avoid the disadvantages of low signal-to-noise ratio caused by background noise and saturation attack in traditional optical remote sensing and quantum illumination radar. Further, the detection method provided by the invention can realize the simultaneous detection of distance information and image information of the object to be measured without the joint measurement of two entangled subsystems, thus greatly reducing the requirement on the detector. Moreover, the probe light interacting with the object is of a different wavelength than the reference light that is ultimately measured, which means that the LiDAR we invented can operate in bands where the detector cannot correspond.

Although the invention has been disclosed as above by a better embodiment, it is not intended to qualify the invention, and any person familiar with the art may, within the spirit and scope of the invention, make some alterations and embellishments, so that the scope of protection of the invention shall be subject to the scope of protection claimed in the claims.

The invention claimed is:

1. A detection method based on quantum induced coherence, wherein
the pump light pump the entangled light source to obtain the first mixed light though the first spontaneous parametric down conversion (SPDC), the first mixed light comprises the pump light, the first reference light and the first probe light, the first reference light and
the first probe light entangle with each other;
the first probe light and the first reference light are separated from the first mixed light, and the first probe light is sent to the object, and the first reference light is sent to the reference light mirror located on the local translation stage;
the first probe light is partially reflected back to the entangled light source in the original way by the object, carrying the information of the object; the first reference light is reflected back to the entangled light source in the original way by the reference light mirror; the pump light is reflected back to the entangled light source in the original way by the pump light mirror to obtain the second mixed light though the second SPDC; the second mixed light comprises the second reference light and the second probe light entangled with each other, the first reference light and the first probe light entangled with each other, and the pump light; the spatial modes of the first reference light and the second reference light overlap, and the spatial modes of the first probe light and the second probe light overlap;
the first reference light and the second reference light are separated from the second mixed light;
the separated first reference light and second reference light are directed to the reference light detector;
the local translation stage is adjusted to scan the optical path of the first reference light, when the visibility of the interference fringes of the two reference lights on the reference light detector is maximum, the parameters of the local translation stage are acquired to obtain the distance information of the object; the image information of the object is obtained according to the visibility of the interference fringes at different positions on the reference light detector.

2. The detection method based on quantum induced coherence described in claim 1, wherein
when the object has only one reflecting surface to the first probe light, the distance information of the object from the entangled light source is obtained according to the local translation stage parameter when the visibility of the interference fringes is maximum;
when the object has multiple reflecting surfaces to the first probe light, the movement of the local translation stage will cause the maximum visibility of the interference fringes on the reference light detector appear multiple times; the thickness information of the object to be measured is obtained according to the parameters of the local translation stage when the visibility of interference fringes is maximum.

3. The detection method based on quantum induced coherence described in claim 1, wherein the wavelengths of the two reference beams are equal and the wavelengths of the two probe beams are equal, the wavelengths of the probe light and the wavelengths of the reference light are not equal, and the wavelengths of the probe light and the reference light are continuously adjustable.

4. The detection method based on quantum induced coherence described in claim 1, wherein the visibility of the interference fringes is proportional to the amplitude reflection coefficient of the object to the first probe light.

5. The detection method based on quantum induced coherence described in claim 1, wherein the spectrum of the two reference beams generated by the entangled light source covers the visible to the infrared band.

6. A detection device based on quantum induced coherence comprising a pumping light source, an entanglement light source, a transmitting and receiving optical component, and a measuring optical component;
the pump light source; the entangled light source is pumped to generate the first spontaneous parametric down conversion to obtain the first mixed light, which comprises the pump light, the first reference light and the first probe light; the first reference light and the first probe light entangled with each other;
transmitting and receiving optical component; the first reference light, the first probe light and the pump light are separated from the first mixed light; the first probe light is partially reflected by the object, carries the information of the object and returns to the entangled light source in the original way; the first reference light is reflected to the entangled light source by the reference light mirror located on the local translation stage; the pump light is reflected back to the entangled light source by the pump light mirror to generate a second spontaneous parametric down conversion to produce a second mixed light; the second mixed light comprises a second reference light and a second probe light entangled with each other, a first reference light and a first probe light entangled with each other, and a pump light; among them, the spatial modes of the first reference light and the second reference light overlap, and the spatial modes of the first probe light and the second probe light overlap;
measuring optical components; the first reference light and the second reference light are separated from the second mixed light and illuminate the reference light detector; the local translation stage is adjusted to scan the optical path of the first reference light, and the parameters of the local translation stage are acquired to obtain the distance information of the object when the visibility of two reference light interference fringes on the reference light detector is maximum, and the image information of the object is obtained according to the visibility of the interference fringes at different positions on the reference light detector.

7. The detection device based on quantum induced coherence described in claim 6, wherein the transmitting and receiving optical components include: a parabolic mirror, a first dichroic mirror, a pump light mirror, a second dichroic mirror, a translation stage and a reference light mirror located on the translation stage;
the parabolic mirror collimates the first mixed light generated by the entangled light source and reflects the first mixed light to the first dichroic mirror;
the first dichroic mirror reflects the pump light in the first mixed light to the pump light reflector;
the first reference light and the first probe light are transmitted through the first dichroic mirror to the second dichroic mirror;
the second dichroic mirror reflects the first probe light to the object;
the first reference light is transmitted through the first dichroic mirror to the reference light mirror on the local translation stage;
the first probe light is reflected by the object in the original path, the first reference light is reflected by the reference light mirror in the original path, and the pump light is reflected by the pump light mirror in the original path; all the three are collected by the parabolic mirror and reflected to the entangled light source.

8. The detection device based on quantum induced coherence described in claim 7, wherein the pump light mirror, the object, and the reference light mirror are all located roughly on the Fourier plane of the parabolic mirror.

9. The detection device based on quantum induced coherence described in claim 6, wherein the measuring optical component comprises a third dichroic mirror, a lens, a filter, and a reference light detector;
the third dichroic mirror reflects the first reference light and the second reference light from the second mixed light emitted by the entangled light source;
the lens collects the first reference light and the second reference light reflected by the third dichroic mirror;
the filter is arranged in front of the reference light detector, and the filter filters out other interfering light so that the first reference light and the second reference light enter the reference light detector;
the reference light detector is used to measure the interference between the first and second reference light.

10. The detection device based on quantum induced coherence described in claim 9, wherein the sensitive surface of the reference light detector is approximately located on the Fourier plane of the lens.

11. The detection device based on quantum induced coherence described in claim 9, wherein the pumped light source is a light source with an optical isolator; the detection device based on quantum induced coherence also includes a wave plate arranged between the pumped light source and a third dichroic mirror to adjust the polarization.

12. The detection device based on quantum induced coherence described in claim 9, wherein
when the object has only one reflecting surface to the first probe light, the reference light detector can obtain the distance information of the object from the entangled light source according to the local translation stage parameter when the visibility of the interference fringe is maximum;
when the object has multiple reflecting surfaces to the first probe light, the movement of the local translation stage will cause the maximum visibility of the interference fringes on the reference light detector appears multiple times; the reference light detector obtains the thickness information of the object according to the local translation stage parameters when the visibility of interference fringes is maximum.

13. The detection device based on quantum induced coherence described in claim 12, wherein the visibility of the interference fringes is proportional to the reflection coefficient of the object to the amplitude of the first probe light.

14. The detection device based on quantum induced coherence described in claim 6, wherein the wavelengths of the two reference beams are equal, the wavelengths of the two probe beams are equal, and the wavelengths of the probe light and the reference light are not equal.

15. The detection device based on quantum induced coherence described in claim 6, wherein the wavelengths of both the probe light and the reference light are continuously tunable.

16. The detection device based on quantum induced coherence described in claim 6, wherein the pump light output by the pump light source is a green laser with a line width of 10 kHZ with a center frequency of 532 nm; the nonlinear crystal used in the entanglement light source is a type-0 periodically polarized lithium niobate crystal with a length of 20 mm, a width of 1 mm and a height of 1 mm.

17. The detection device based on quantum induced coherence described in claim 6, wherein the entangled light source is installed in a constant temperature oven, and the temperature of the entangled light source is controlled to make the entangled light source meet different phase matching conditions.

18. The detection device based on quantum induced coherence described in claim 17, wherein reference light of 893 nm and probe light of 1316 nm are obtained when the temperature of the entangled light source is 146.4 degrees Celsius.

19. The detection device based on quantum induced coherence described in claim 9, wherein in that the reference light detector is a planar array camera, which receives an image information with a two-dimensional structure; and different positions on the image information correspond to entangled photon pairs with different wavelength combinations.

20. The detection device based on quantum induced coherence described in claim 6, wherein the spectrum of the two reference beams produced by the entangled light source covers the visible to infrared band.
